(19) United States
(12) Patent Application Publication
(10) Pub. No.: US 2011/0069369 A1
(43) Pub. Date: Mar. 24, 2011

(54) DISPLAY DEVICE

(75) Inventors: Jae Byung PARK, Seoul (KR); Seon-Tae Yoon, Seoul (KR)

(73) Assignee: Samsung Electronics Co., Ltd., Suwon-si (KR)

(21) Appl. No.: 12/828,613

(22) Filed: Jul. 1, 2010

(30) Foreign Application Priority Data
Sep. 23, 2009 (KR) 10-2009-0089969

(51) Int. Cl. G02B 26/02; G02B 26/00

(52) U.S. Cl. 359/230; 359/290; 977/774; 977/834; 977/952

(57) ABSTRACT

A display device is provided including a first substrate a second substrate facing the first substrate. The device also includes a micro-electro-mechanical system (MEMS) element disposed between the first substrate and the second substrate. The device further includes a color conversion member disposed between one of the first substrate and the second substrate, and the MEMS element. A light source is provided to emit light toward the first substrate, wherein the color conversion member absorbs the light from the light source, and represents at least one color by the energy according to the absorbed light.

### CROSS-REFERENCE TO RELATED APPLICATION

This application claims priority from and the benefit of Korean Patent Application No. 10-2009-0089969 filed on Sep. 23, 2009, which is hereby incorporated by reference for all purposes as if fully set forth herein.

### BACKGROUND OF THE INVENTION

1. Field of the Invention

Exemplary embodiments of the present invention relates to a display device, more particularly, the present invention relate to a display device capable of realizing images by using micro-electro-mechanical systems (MEMS).

2. Description of the Background

Various types of flat panel displays have been adopted as a next generation display device. For example, a flat panel display can provide user with a thin but fine quality image by using micro-electro-mechanical system (MEMS). The MEMS is a micro-minute processing technique that offers to process an electronic device having a size ranging from several nanometers to several millimeters. The using of the MEMS has resulted in high photo-efficiency that has found significant success in manufacturing the liquid crystal display.

However, the display device using a traditional MEMS has only an on-off characteristic such as for reflecting or not, or closing or opening a shutter. Accordingly, the MEMS element must be driven several times during a short time for representing grays and colors. A conventional display device includes light sources emitting at least three colors such that the light sources are required to sequentially driven by the time division scheme, and simultaneously, the MEMS of each subpixels need to be driven together to represent the desired color—consequently rendering a process difficult to obtain a high speed driving margin when it is applied to a large area display device. As a result, the driving margin is narrow.

Therefore, there is a need of a display device providing a simple process yet a high speed driving margin.

### SUMMARY OF THE INVENTION

These and other needs are addressed by the present invention, in which exemplary embodiments provide a display device capable of easily realizing colors compared with a conventional display device.

Additional features of the invention will be set forth in the description which follows, and in part will be apparent from the description, or may be learned by practice of the invention.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

Exemplary embodiments of the present invention disclose a display device. The device includes a first substrate and a second substrate facing the first substrate. The device also includes a micro-electro-mechanical system (MEMS) element disposed between the first substrate and the second substrate. The device includes a color conversion member disposed between one of the first substrate, the second substrate, and the MEMS element. The device further includes a light source to emit light toward the first substrate. The color conversion member is configured to absorb the emitted light and to represent at least one color that is different wavelength of the emitted light by absorbing the emitted light.

Exemplary embodiments of the present invention disclose a method for manufacturing a liquid crystal display. The method includes disposing one substrate facing another substrate to form a micro-electro-mechanical system (MEMS) element between the substrates. The method also includes forming a color conversion member between one of the respective substrate and the MEMS element. The method also includes providing a light source to emit light, wherein the color conversion member is provided to selectively absorb one or more wavelengths of the emitted light that is not represent for display.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a cross-sectional view of a display device, according to exemplary embodiments of the present invention.

FIG. 2 is a top plan view of an exemplary arrangement of a pixel of the display device of FIG. 1.

FIG. 3 is a cross-sectional view of a display device, according to exemplary embodiments of the present invention.

FIG. 4 is a cross-sectional view of a display device, according to exemplary embodiments of the present invention.

### DETAILED DESCRIPTION OF THE ILLUSTRATED EMBODIMENTS

An apparatus and method of manufacturing display device is disclosed. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

It is understood that when an element such as a layer, a film, a region, or a substrate is referred to as being “on” another element, it can be directly on the other element or intervening elements may also be present. In contrast, when an element is referred to as being “directly on” another element, there are no intervening elements present.

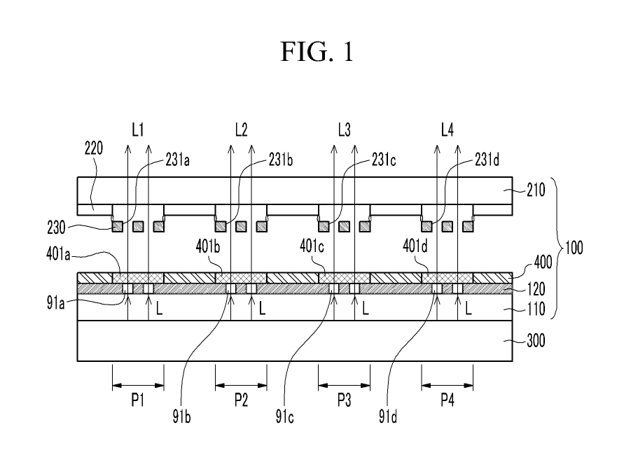

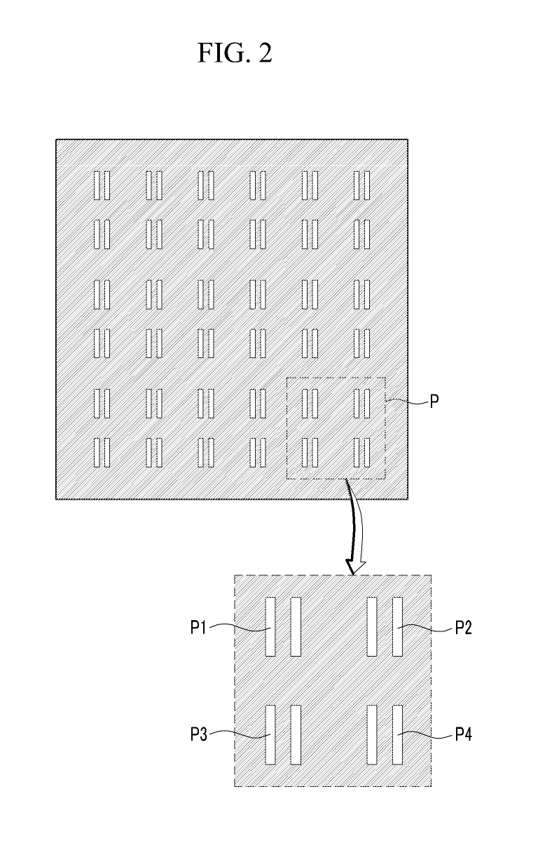

Now, a display device according to exemplary embodiments of the present invention is described with reference to FIG. 1 and FIG. 2.

FIG. 1 is a cross-sectional view of a display device, according to exemplary embodiments of the present invention, and FIG. 2 is a top plan view of an exemplary arrangement of a pixel of the display device of FIG. 1.

Referring to FIG. 1 and FIG. 2, a display device may include a display panel 100 including a lower substrate 110 and an upper substrate 210 facing each other, and a backlight unit 300 is configured to provide light to the display panel 100.

The lower substrate 110 and the upper substrate 210 may be made of a transparent insulating material such as transparent glass or plastic.

An aperture plate 120 having a plurality of lower openings 91a, 91b, 91c, and 91d may be formed on the lower substrate 110. The aperture plate 120 can be made of a material that blocks the light from reaching the lower substrate 110, and may allow to pass the light through the plurality of openings 91a, 91b, 91c, and 91d.

A shutter 230 having a plurality of upper openings 231a, 231b, 231c, and 231d and a shutter driving member 220 can be formed on the upper substrate 210.

The upper openings 231a, 231b, 231c, and 231d of the shutter 230 may have the same plane shape as that of the lower openings 91a, 91b, 91c, and 91d of the aperture plate 120. The shutter 230 may be moved in the direction parallel to the substrates 110 and 210, along with a horizontal direction based on the substrate, and when the shutter 230 is positioned at a reference position, the shutter 230 may cover the lower openings 91a, 91b, 91c, and 91d of the corresponding aperture plate 120. However, it is noted that the shape of the upper openings 231a, 231b, 231c, and 231d may be different from the shape of the lower openings 91a, 91b, 91c, and 91d. By moving the shutter 230, the lower openings 91a, 91b, 91c, and 91d and the upper openings 231a, 231b, 231c, and 231d can be aligned to corresponding to one another. In some examples, the lower openings 91a, 91b, 91c, and 91d may be covered by an opaque portion of the shutter 230, and the shape of the upper openings 231a, 231b, 231c, and 231d and the lower openings 91a, 91b, 91c, and 91d may variously be changed.

The shutter 230 can be connected to the shutter driving member 220 supporting the shutter 230 to be floated on the upper substrate 210 and that is capable of moving the shutter 230 at the reference position in the horizontal direction. The shutter driving member 220 may control the shutter 230 to move in the right and left directions, and may have an elastic force to return the shutter 230 to the reference position after the shutter 230 is moved in the right and left directions.

Each shutter 230 may be separated, and two or more shutters 230 are connected to each other by way of configuration of manufacturing process.

The display panel 100 may further include a color conversion member 400 disposed between the lower substrate 110 and the upper substrate 210. The color conversion member 400 may include a first color conversion member 401a, a second color conversion member 401b, a third color conversion member 401c, and a fourth color conversion member 401d.

Each pixel P of the display panel 100 may include a first subpixel P1, a second subpixel P2, a third subpixel P3, and a fourth subpixel P4.

The lower openings 91a, 91b, 91c, and 91d of the lower substrate 110, may include one shutter 230 corresponding thereto, and the shutter driving member 220 may form one MEMS element.

Next, an operation of the MEMS element will be described.

When the shutter 230 is positioned at the reference position by the shutter driving member 220, the shutter 230 may cover the lower openings 91a, 91b, 91c, and 91d to block the light from passing through the lower openings 91a, 91b, 91c, and 91d thereby forming a black color because the light cannot be reached. In some examples, when the shutter 230 is horizontally moved by the shutter driving member 220, the upper openings 231a, 231b, 231c, and 231d, and the lower openings 91a, 91b, 91c, and 91d can be aligned such that the light passing through the lower openings 91a, 91b, 91c, and 91d can be reached to the respective upper openings 231a, 231b, 231c, and 231d. As a consequence, the light may be emitted to an external region of the upper openings 231a, 231b, 231c, and 231d that can be recognized. In some examples, the corresponding alignment degree of the upper openings 231a, 231b, 231c, and 231d and the lower openings 91a, 91b, 91c, and 91d may be adjusted to display colors, for example, a gray. The adjustment can be controlled by adjusting the distance of the horizontal movement of the shutter 230.

For example, the shutters 230 disposed in respective of the first subpixel P1, the second subpixel P2, the third subpixel P3, and the fourth subpixel P4 may be driven separately such that the subpixels may display different tone of gray.

The backlight unit 300 may include a light source (not shown) and a supporting unit (not shown) to provide the light source. The display device according to exemplary embodiments of the present invention may include a blue light source or a white light source. For example, a blue light emitting diode (LED) or an ultra violet (UV) diode may be included. As the light source, by way of configuration, a fluorescent lamp such as a cold cathode fluorescent lamp (CCFL) or an external electrode fluorescent lamp (EEFL), or a discharge lamp (DL) instead of the light emitting diode (LED), may be used as an example. The supporting unit may include a reflection member (not shown) to guide the light emitted from the light source toward the lower substrate 110.

FIG. 2 is a top plan view of an exemplary arrangement of a pixel of the display device of FIG. 1. Referring to FIG. 2, a first subpixel P1 is provided to display a first color, a second subpixel P2 is provided to display a second color, a third subpixel P3 is provided to display a third color, and a fourth subpixel P4 is provided to display a fourth color, and these subpixels may alternately be provided.

In some examples, the first subpixel P1, the second subpixel P2, and the third subpixel P3 as a unit pixel to realize full-color display as one of primary colors such as a red, a green, and a blue, or a magenta, a yellow and a cyan. For example, the fourth subpixel P4 may display a white. By adding the pixel with the white color, the luminance may be increased. By way of configuration of manufacturing process, the fourth subpixel P4 may be omitted.

The subpixels including the first subpixel P1, the second subpixel P2, the third subpixel P3, and the fourth subpixel P4 may be formed one group form one pixel, and may repeatedly be arranged according to rows and/or columns. However, the arrangement and the shape of the pixels may variously be changed by way of configurations.

For example, the lower opening 91a, the upper opening 231a, and the first color conversion member 401a may be disposed on the region of the first subpixel P1, the lower opening 91b, the upper opening 231b, and the second color conversion member 401b may be disposed on the region of the second subpixel P2, the lower opening 91c, the upper opening 231c, and the third color conversion member 401c may be disposed on the region of the third subpixel P3, and the lower opening 91d, the upper opening 231d, and the fourth color conversion member 401d may be disposed on the region of the fourth subpixel P4.

The color conversion member 400 may be disposed at the position corresponding to the respective of the lower openings 91a, 91b, 91c, and 91d of the aperture plate 120.

The color conversion member 400 may be made of one material selected from the group consisting of polydiacetylene, transacetylene, phosphor, nanocrystal, and quantum dots (CdSe/ZnS, CdS/ZnS, InGaP/ZnS).

For example, among the first color conversion member 401a, the second color conversion member 401b, and the third color conversion member 401c, the red conversion member may include one material selected from the group consisting of CaAlSiN3:Eu, (Sr,Ca)AlSiN3:Eu, Y(V,P)O4:Eu, (Y,Gd)BO3:Eu, and combinations of the group, and the green conversion member may include one material selected from the group consisting of (Ba,Sr)2SiO4:Eu, Ca3(Sc,Mg)2Si3O12:Ce, CaSc2O4:Ce, Zn2SiO4:Mn, (Zn,A)2SiO4:Mn, and combinations of the group.

In some examples, the composition for the formation of the color converting members 400 can be manufactured by dispersing a material with a controlled stoichiometric ratio in a vehicle in which a binder resin can be dissolved with a solvent. Examples of the binder resin may include a cellulose resin such as ethyl cellulose or an acryl resin, but they are not limited thereto. The solvent may be an organic solvent such as hexanetriol, polypropylene glycol, butyl carbitol acetate, and terpineol, but is not limited thereto. Also, since the manufacture of the composition for the formation of the color converting member 400 may be an example, therefore, the manufacturing method of the composition is not limited thereto.

The color converting member 400 may be formed by manufacturing the composition with a desired shape through various methods such as a photolithography, a screen printing, an inkjet printing, and a laser printing.

The first color conversion member 401a can absorb the light L incident from the light source to obtain the energy thereby emitting the first color L1 such that the first subpixel P1 can display the first color L1. The second color conversion member 401b can absorb the light L incident from the light source to obtain the energy thereby emitting the second color L2 such that the second subpixel P2 can display the second color L2. The third color conversion member 401c can absorb the light L incident from the light source to obtain the energy thereby emitting the third color L3 such that the third subpixel P3 can display the third color L3. And the fourth color conversion member 401d can absorb the light L incident from the light source to obtain the energy thereby emitting the fourth color L4 such that the fourth subpixel P4 displays the fourth color L4. A combination of the first color L1, the second color L2, the third color L3, and the fourth color L4 can display the desired various types of images.

For the purpose of illustration of embodiments, when the backlight unit 300 only includes a blue light source, and the first subpixel P1, the second subpixel P2, and the third subpixel P3 can be the pixels respectively displaying a red, a green, and a blue. In this example, the third color conversion member 401c of the third subpixel P3 may be omitted. That is, the color conversion member can display the blue among the first color conversion member 401a, the second color conversion member 401b. In this example, the third color conversion member 401c of the color conversion member 400 may be omitted.

For the purpose of illustration of embodiments, when the backlight unit 300 only includes the white color light source, the fourth color conversion member 401d of the fourth subpixel P4 may be omitted. That is, the color conversion member can display the white color among the color conversion members 400 that may be omitted.

It is contemplated that one color conversion member may be omitted according to the color of the light source such that the structure of the display device and the manufacturing process may be simplified, and the manufacturing cost of the display device may be reduced.

In some examples, the shutter 230 may be positioned in each of the subpixel P1, subpixel P2, subpixel P3, and subpixel P4 that can be disposed on the respective reference position. The shutter 230 can be moved in a horizontal direction by the shutter driving member 220 disposed in the subpixel P1, subpixel P2, subpixel P3, and subpixel P4 of the pixel P such that the light emitted from the backlight unit 300 can pass through the lower openings 91a, 91b, 91c, and 91d, the color conversion members 401a, 401b, 401c, and 401d, and through the upper openings 231a, 231b, 231c, and 231d of the desired region of the subpixels P1, P2, P3, and P4 thereby being displayed. Accordingly, one pixel P can display the desired color using by the combination of the colors represented by the subpixel P1, subpixel P2, subpixel P3, and subpixel P4.

According to the exemplary embodiments of the present invention, a display device may include one light source configured to emit one color, for example, a blue or a white, and also may include the color conversion member 400 to convert the blue light or the white color light into a desired colors such that the light source may not sequentially be driven by a time division scheme, and the light source can only be driven by on/off. According to exemplary embodiments of the present invention, it is contemplated that without the time division scheme associated with driving the light source, the desired color may be represented by the on/off of the MEMS of each subpixel such that the driving method can be simplified. As a consequence of the simplification of the process, it is applicable to the large area of the display device.

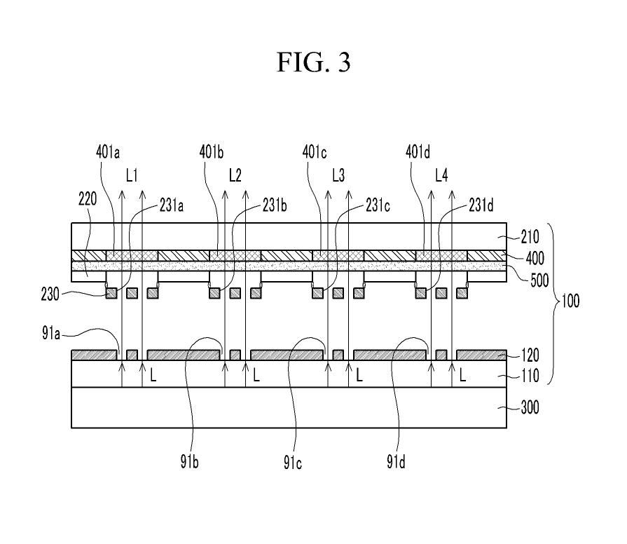

Next, a display device according to exemplary embodiments of the present invention will be described with reference to FIG. 3. FIG. 3 is a cross-sectional view of a display device according to exemplary embodiments of the present invention.

Referring to FIG. 3, a display device may include a display panel 100 including a lower substrate 110 and an upper substrate 210 facing each other, and a backlight unit 300 is configured to provide light to the display panel 100.

In some examples, an aperture plate 120 having a plurality of lower openings 91a, 91b, 91c, and 91d can be formed on the lower substrate 110. A color conversion member 400 including a first color conversion member 401a, a second color conversion member 401b, a third color conversion member 401c, and a fourth color conversion member 401d can be formed on the upper substrate 210, a reflection member 500 can be formed on the color conversion member 400, and a shutter 230 having a plurality of upper openings 231a, 231b, 231c, and 231d and a shutter driving member 220 can be formed.

However, a different aspect from the display device of FIG. 1 may be provided, according to exemplary embodiments of the present invention in which the color conversion member 400 may be formed on the upper substrate 210, and the reflection member 500 can be formed on the color conversion member 400. The reflection member 500 may be provided to transmit a portion of the light and to reflect a portion of the light according to a wavelength of the light. For example, when the light source is blue light, the blue light may be transmitted and the remaining light may be reflected, and when the light source is white light, the white light may be transmitted and the remaining light may be reflected.

The reflection member 500 can be configured to prevent back-scattering after the color conversion member 400 absorbs the light L of the light source passing through the backlight unit 300, the lower openings 91a, 91b, 91c, and 91d, and the upper openings 231a, 231b, 231c, and 231d. In some examples, the first color L1, the second color L2, the third color L3, the fourth color L4 generated from the energy of the absorbed light can be emitted from the color conversion member 400 such that the efficiency of the light emitted from the color conversion member 400 is increased, and thereby the quality of color display may be increased.

Various aspects of the exemplary embodiments according to FIG. 1 and FIG. 2 can be applied to the present invention.

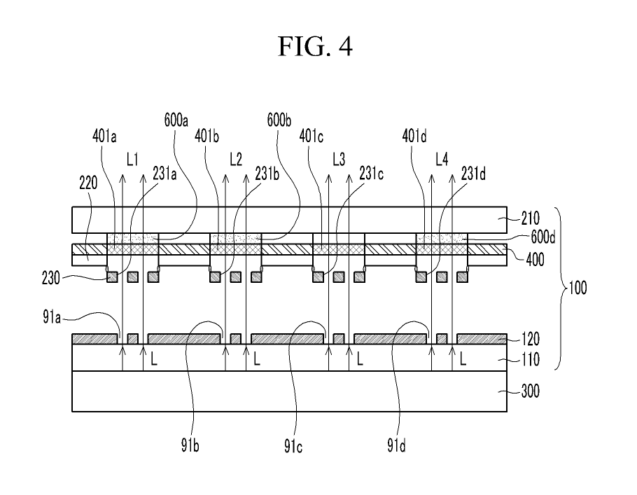

Next, a display device will be described with reference to FIG. 4. FIG. 4 is a cross-sectional view of a display device, according to exemplary embodiments of the present invention.

Referring to FIG. 4, a display device may include a display panel 100 including a lower substrate 110 and an upper substrate 210 facing each other, and a backlight unit 300 is configured to provide light to the display panel 100.

In some examples, an aperture plate 120 having a plurality of lower openings 91a, 91b, 91c, and 91d can be formed on the lower substrate 110. A plurality of blue light filters 600a, 600b, and 600d can be formed on the upper substrate 210. A color conversion member 400 including a first color conversion member 401a, a second color conversion member 401b, a third color conversion member 401c, and a fourth color conversion member 401d can be formed on the blue light filters 600a, 600b, and 600d. And a shutter 230 having a plurality of upper openings 231a, 231b, 231c, and 231d and a shutter driving member 220 can be formed on the color conversion member 400. Also, a backlight unit 300 of the display device may include a light source emitting blue light.

However, a different aspect from the display device of FIG. 1, the color conversion member 400 can be formed on the upper substrate 210, and the blue light filters 600a, 600b, and 600d can be formed between the upper substrate 210 and the color conversion member 400.

When the color conversion member 400 absorbs the blue light L passing through the lower openings 91a, 91b, 91c, and 91d, and the upper openings 231a, 231b, 231c, and 231d, and convents the blue light L into the first color L1, the second color L2, and the fourth color L4 after the backlight unit 300 emitting light, the blue light filters 600a, 600b, and 600d are provided to filter the blue light included in the first color L1, the second color L2, and the fourth color L4, and thereby the color purity of the first color L1, the second color L2, and the fourth color L4 may be increased and a reference for determining a color displayed on the display device i.e.,—the color reproducibility of the display device may be improved.

Various characteristics of the exemplary embodiments according to FIG. 1 and FIG. 2 can be applied to the present invention.

A display device according to exemplary embodiments of the present invention may include a first substrate and a second substrate facing the first substrate. An MEMS element may be disposed between the first substrate and the second substrate. A color conversion member disposed between one of the first substrate and the second substrate, and the MEMS element. And a light source is provided to emit light toward the first substrate, wherein the color conversion member absorbs the light from the light source and represents at least one color by the energy of the absorbed light.

The color conversion member may include one material selected from the group consisting of polydiacetylene, transacetylene, phosphor, nanocrystal, and quantum dots (CdSe/ZnS, CdS/ZnS, InGaP/ZnS).

The MEMS element may include an aperture plate formed on the first substrate and including a plurality of first openings, a shutter formed between the first substrate and the second substrate and including a plurality of second openings, and a driving member formed on the second substrate and driving the shutter.

The shutter may be moved horizontally between a first position and a second position.

The first opening may be covered by the shutter when the shutter is disposed at the first position, and the first opening and the second opening may be disposed in one line when the shutter is disposed at the second position.

If the light source may emit a blue light, the color conversion member may include a red conversion member and a green conversion member. The red conversion member may absorb the blue light and emit red light, the green conversion member may absorb the blue light and emit green light, and the blue light that is not passed through the color conversion member. The red light emitted from the red conversion member, and the green light emitted from the green conversion member may be combined to display images.

The red conversion member may include one material selected from the group consisting of CaAlSiN3:Eu, (Sr,Ca)AlSiN3:Eu, Y(V,P)O4:Eu, (Y,Gd)BO3:Eu, and combinations thereof.

The green conversion member may include one material selected from the group consisting of (Ba,Sr)2SiO4:Eu, Ca3(Sc,Mg)2Si3O12:Ce, CaSc2O4:Ce, Zn2SiO4:Mn, (Zn,A)2SiO4:Mn, and combinations thereof.

The color conversion member may be made of one material selected from the group consisting of polydiacetylene, transacetylene, phosphor, nanocrystal, and quantum dots (CdSe/ZnS, CdS/ZnS, InGaP/ZnS).

The display device may further include a reflection member disposed between the first substrate and the color conversion member, and the reflection member may pass the light emitted from the light source and reflect the light of the remaining wavelengths.

The light source may emit blue or white light.

The display device may further includes a light filter disposed between the second substrate and the color conversion member, and the light filter filters light having the same wavelength range as the light emitted from the light source.

The light source may emit blue light.

The light source may be selected from the group of a light emitting diode (LED), an organic electroluminescent (EL) element, an inorganic electroluminescent (EL) element, a cold cathode fluorescent lamp (CCFL), an external electrode fluorescent lamp (EEFL), a discharge lamp (DL), and combinations thereof.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
a first substrate and a second substrate facing the first substrate;
a micro-electro-mechanical system (MEMS) element disposed between the first substrate and the second substrate;
a color conversion member disposed between one of the first substrate, the second substrate, and the MEMS element; and
a light source to emit light toward the first substrate,
wherein the color conversion member to absorb the emitted light and to represent at least one color that is different wavelength of the emitted light by absorbing the emitted light.

2. The display device of claim 1, wherein
the color conversion member includes one material selected from the group consisting of polydiacetylene, transacetylene, phosphor, nanocrystal, and quantum dots (CdSe/ZnS, CdS/ZnS, InGaP/ZnS).

3. The display device of claim 1, wherein
the MEMS element comprises
an aperture plate formed on the first substrate and comprising a plurality of first openings,
a shutter formed between the first substrate and the second substrate and comprising a plurality of second openings, and
a driving member formed on the second substrate to drive a shutter.

4. The display device of claim 3, wherein
the shutter is moved in a horizontal direction from a first position and to a second position.

5. The display device of claim 4, wherein
one of the first openings is covered by the shutter when the shutter is disposed at the first position, and
one of the first openings and one of the second openings are disposed in one line when the shutter is disposed at the second position.

6. The display device of claim 3, wherein
the light source is provided to emit blue light,
the color conversion member includes a red conversion member and a green conversion member,
the red conversion member is provided to absorb blue light and to emit red light, the green conversion member is provided to absorb blue light and to emit green light, and the blue light not passing through the color conversion member, and wherein the red light and the green light are combined to display images.

7. The display device of claim 6, wherein
the red conversion member comprises one material selected from the group consisting of CaAlSiN3:Eu, (Sr,Ca)AlSiN3:Eu, Y(V,P)O4:Eu, (Y,Gd)BO3:Eu, and combinations of the group.

8. The display device of claim 6, wherein
the green conversion member comprises one material selected from the group consisting of (Ba,Sr)2SiO4:Eu, Ca3(Sc,Mg)2Si3O12:Ce, CaSc2O4:Ce, Zn2SiO4:Mn, (Zn,A)2SiO4:Mn, and combinations of the group.

9. The display device of claim 3, wherein
the color conversion member is made of one material selected from the group consisting of polydiacetylene, transacetylene, phosphor, nanocrystal, and quantum dots (CdSe/ZnS, CdS/ZnS, InGaP/ZnS).

10. The display device of claim 1, further comprising:
a reflection member disposed between the first substrate and the color conversion member to pass the light emitted from the light source, and to reflect the remaining wavelengths of light through the absorbing the emitted light.

11. The display device of claim 10, wherein
the color conversion member is made of one material selected from the group consisting of polydiacetylene, transacetylene, phosphor, nanocrystal, and quantum dots (CdSe/ZnS, CdS/ZnS, InGaP/ZnS).

12. The display device of claim 10, wherein
the light source is provided to emit a blue light or a white light.

13. The display device of claim 1, further comprising:
a light filter disposed between the second substrate and the color conversion member to filter light having the same wavelength range as that of the emitted light.

14. The display device of claim 13, wherein
the color conversion member comprises one material selected from the group consisting of polydiacetylene, transacetylene, phosphor, nanocrystal, and quantum dots (CdSe/ZnS, CdS/ZnS, InGaP/ZnS).

15. The display device of claim 13, wherein
the light source is provided to emit a blue light.

16. The display device of claim 1, wherein
the light source is selected from the group of a light emitting diode (LED), an organic electroluminescent (EL) element, an inorganic electroluminescent (EL) element, a cold cathode fluorescent lamp (CCFL), an external electrode fluorescent lamp (EEFL), a discharge lamp (DL), and combinations of the group.

17. The display device of claim 1, wherein
the light source is provided to emit a blue light or a white light.

18. A method, comprising:
disposing one substrate member facing another substrate member to form a micro-electro-mechanical system (MEMS) element between the substrates;
forming a color conversion member between one of the respective substrate members and the MEMS element; and
providing a light source to emit light, wherein the color conversion member is provided to selectively absorb one or more wavelengths of the emitted light that is not represent for display.

19. The method of claim 18, wherein
the MEMS element comprises
an aperture plate formed on one of the substrate members and comprising a plurality of first openings,
a shutter formed between the substrate members and comprising a plurality of second openings, and
a driving member formed on the other substrate member to drive a shutter.

20. The method of claim 19, wherein
the shutter is moved in a horizontal direction from a first position and to a second position,
one of the first openings is covered by the shutter when the shutter is disposed at the first position, and
one of the first openings and one of the second openings are disposed in one line when the shutter is disposed at the second position.
